(19) United States
(12) Patent Application Publication
(10) Pub. No.: US 2026/0221882 A1
(43) Pub. Date: Jul. 30, 2026

(54) POWER CONVERSION DEVICE

(71) Applicant: Panasonic Intellectual Property Management Co., Ltd., Osaka (JP)

(72) Inventors: Ryusuke KANOMATA, Osaka (JP); Sho HIURA, Osaka (JP); Shinji UJITA, Osaka (JP); Kenichiro TANAKA, Hyogo (JP)

(21) Appl. No.: 19/148,602

(22) PCT Filed: Nov. 28, 2023
(86) PCT No.: PCT/JP2023/042500

§ 371 Date: Jul. 16, 2025

(30) Foreign Application Priority Data
Feb. 8, 2023 (JP) 2023-017403

(51) Int. Cl. H02M 3/158; H02M 1/08

(52) U.S. Cl. CPC H02M 3/1586; H02M 1/08

(57) ABSTRACT

A power conversion device includes first to fourth switches, first and second inductors, and a first bootstrap circuit including a BS capacitor whose one end is connected to a second node between the third switch and a fourth switch and whose other end is connected to a drive circuit for driving the third switch. The first and second inductors are magnetically connected to each other by a positive coupling coefficient, and the BS capacitor is charged by turning off the first switch at a timing when the voltage of the second node is a first voltage or higher, where the first voltage is determined based on the positive coupling coefficient and the voltage of the third input/output terminal.

### TECHNICAL FIELD

The present invention relates to power conversion devices.

### BACKGROUND ART

Patent Literature (PTL) 1 describes techniques of switching among the following modes in a two-phase converter: a mode of operating only a first-phase circuit; a mode of alternately operating the first-phase circuit and a second-phase circuit; and a mode of simultaneously operating the first-phase circuit and the second-phase circuit to operate the two-phase converter with high efficiency.

### CITATION LIST

### Patent Literature

[PTL 1] Japanese Patent No. 5780074

### SUMMARY OF INVENTION

In the converter as described in PTL 1, bootstrap circuits are widely used to ensure the drive voltage of switches on the High side. The converter described in PTL 1 is configured by two phases to obtain high output, but single-phase operation is performed at low power since efficiency decreases when two-phase operation is performed at low power.

In a two-phase buck converter that uses bootstrap circuits, however, when switching is performed between single-phase operation and two-phase operation for improved efficiency, a bootstrap capacitor included in a bootstrap circuit may not be charged and the second-phase circuit may not be able to operate normally when single-phase operation is switched to two-phase operation.

Although the second-phase circuit can be operated normally by using, for instance, isolated power supply, there are problems such as increased cost and size. Although it is conceivable to perform precharge operation for the second-phase circuit when switching to two-phase operation is performed, there is a problem of control complications.

### Solution to Problem

A power conversion device according to the present disclosure is configured by n phases where n is an integer greater than or equal to 2, and includes: a first switch provided on a first path connecting a first input/output terminal and a second input/output terminal; a second switch provided on the first path and connected to the first switch in series; a first inductor provided on a second path connecting a third input/output terminal and a first node between the first switch and the second switch on the first path; a third switch provided on a third path connecting the first input/output terminal and the second input/output terminal, the third path being different from the first path; a fourth switch provided on the third path and connected to the third switch in series; a second inductor provided on a fourth path connecting the third input/output terminal and a second node between the third switch and the fourth switch on the third path; and a first bootstrap circuit including a bootstrap capacitor whose one end is connected to the second node and whose other end is connected to a drive circuit for driving the third switch. The first inductor and the second inductor are magnetically coupled to each other by a positive coupling coefficient. When the third switch and the fourth switch are in an off-state and the power conversion device performs single-phase operation by turning on and off the first switch and the second switch, the bootstrap capacitor is charged by turning off the first switch from an on-state at a timing when the voltage of the second node is a first voltage or higher. The first voltage is determined based on the positive coupling coefficient and the voltage of the third input/output terminal.

It should be noted that these general or specific aspects may be implemented by a system, a method, an integrated circuit, a computer program, or a computer-readable recording medium such as a CD-ROM, or any combination of a system, a method, an integrated circuit, a computer program, or a recording medium.

According to one aspect of the present disclosure, it is possible to provide a power conversion device that uses bootstrap circuits capable of reducing cost and size while inhibiting control complications.

### BRIEF DESCRIPTION OF DRAWINGS

FIG. 1 is a configuration diagram illustrating one example of a power conversion device according to an embodiment.

FIG. 2 is a diagram for illustrating that a second-phase circuit cannot operate normally when the operation of the power conversion device according to the embodiment is switched to two-phase operation.

FIG. 3 is a flowchart illustrating one example of the operation of the power conversion device according to the embodiment.

FIG. 4 is a diagram for illustrating one example of switching conditions of a first switch for charging a bootstrap capacitor when a coupling coefficient for the power conversion device according to the embodiment is positive.

FIG. 5 is a diagram for illustrating another example of charging timing of a bootstrap capacitor when a coupling coefficient for the power conversion device according to the embodiment is positive.

FIG. 6 is a diagram for illustrating one example of adjustment of an on-period and an off-period of the first switch in the power conversion device according to the embodiment.

FIG. 7 is a flowchart illustrating another example of the operation of the power conversion device according to the embodiment.

FIG. 8 is a diagram for illustrating another example of switching conditions of the first switch for charging a bootstrap capacitor when a coupling coefficient for the power conversion device according to the embodiment is positive.

FIG. 9 is a diagram for illustrating one example of coupling coefficient conditions for charging a bootstrap capacitor irrespective of switching of the first switch when a coupling coefficient for the power conversion device according to the embodiment is positive.

FIG. 10 is a diagram for illustrating one example of switching conditions of the first switch for charging a bootstrap capacitor when a coupling coefficient for the power conversion device according to the embodiment is negative.

FIG. 11 is a diagram for illustrating another example of the switching condition of the first switch for charging a bootstrap capacitor when a coupling coefficient for the power conversion device according to the embodiment is negative.

FIG. 12 is a configuration diagram illustrating one example of a power conversion device according to other embodiment.

### DESCRIPTION OF EMBODIMENTS

Hereinafter, an embodiment of the present disclosure will be described with reference to the drawings.

It should be noted that the embodiments described below each show a general or specific example of the present disclosure. The numeric values, shapes, materials, elements, arrangement and connection of the elements, steps, an order of steps, etc., indicated in the following embodiments are mere examples, and do not intend to limit the present disclosure.

### Embodiment

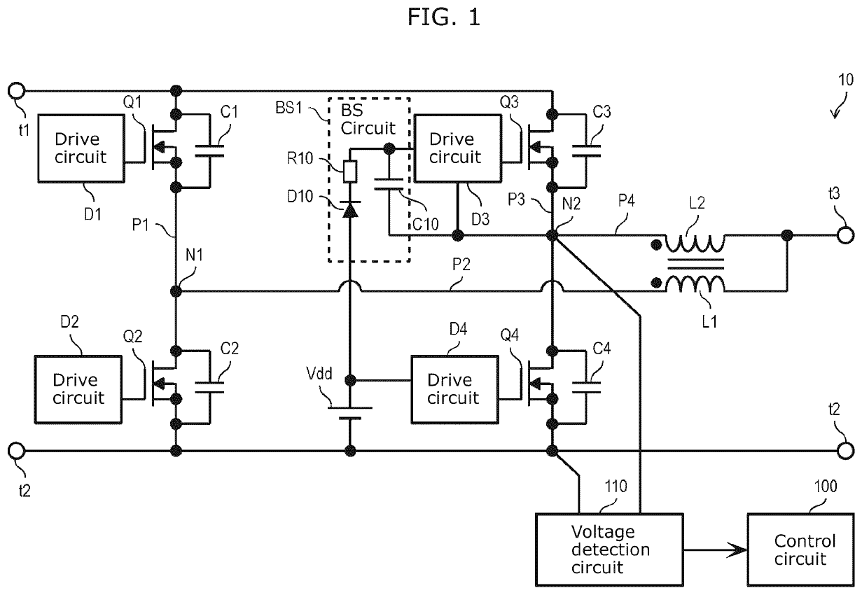

A power conversion device according to an embodiment will be described with reference to FIG. 1 through FIG. 11.

FIG. 1 is a configuration diagram illustrating one example of power conversion device 10 according to the embodiment.

Power conversion device 10 is a buck-type converter (buck converter) that decreases an input voltage to a predetermined voltage and outputs the decreased voltage. Power conversion device 10 includes input/output terminals t1, t2, and t3. Input/output terminal t1 is one example of a first input/output terminal, input/output terminal t2 is one example of a second input/output terminal, and input/output terminal t3 is one example of a third input/output terminal. Input/output terminal t1 is an input terminal to which a voltage is input, input/output terminal t2 is a ground terminal connected to the ground, and input/output terminal t3 is an output terminal from which a voltage is output. The voltage of input/output terminal t1 means the voltage between input/output terminal t1 and input/output terminal t2, and is an input voltage to be input to power conversion device 10. The voltage of input/output terminal t3 means the voltage between input/output terminal t3 and input/output terminal t2, and is an output voltage to be output from power conversion device 10.

Power conversion device 10 is an interleaved-type n-phase power conversion device, where n is an integer greater than or equal to 2. Power conversion device 10 includes n circuits each including: a control switch provided on a path connecting input/output terminal t1 and input/output terminal t2; a synchronous rectifier switch provided on the path and connected to the control switch in series; and an inductor provided on a path connecting input/output terminal t3 and a connection node between the control switch and the synchronous rectifier switch on the path connecting input/output terminal t1 and input/output terminal t2. Hereinafter, power conversion device 10 configured by two phases and including two circuits among the n circuits will be described, but power conversion device 10 may be a power conversion device configured by three or more phases. In other words, power conversion device 10 may include three or more circuits.

Power conversion device 10 includes switches Q1, Q2, Q3, and Q4, inductors L1 and L2, bootstrap (BS) circuit BS1, drive circuits D1, D2, D3, and D4, voltage detection circuit 110, and control circuit 100. Switches Q1 and Q2, and inductor L1 are first-phase circuits in power conversion device 10 configured by two phases. Switches Q3 and Q4, and inductor L2 are second-phase circuits in power conversion device 10 configured by two phases.

Switch Q1 is one example of a first switch provided on path P1 connecting input/output terminal t1 and input/output terminal t2. Path P1 is one example of a first path. Switch Q1 is a switch on the High side of the first-phase circuit. Switch Q2 is one example of a second switch provided on path P1 and connected to switch Q1 in series. Switch Q2 is a switch on the Low side of the first-phase circuit. Switch Q3 is one example of a third switch provided on path P3 that is different from path P1 and connects input/output terminal t1 and input/output terminal t2. Path P3 is one example of a third path. Switch Q3 is a switch on the High side of the second-phase circuit. Path P3 is one example of a third path. Switch Q4 is one example of a fourth switch provided on path P3 and connected to switch Q3 in series. Switch Q4 is a switch on the Low side of the second-phase circuit.

Switch Q1 is, for example, an N-channel metal oxide semiconductor field effect transistor (MOSFET). In FIG. 1, the parasitic capacity of switch Q1 is indicated by capacitor C1, and capacitor C1 is connected to switch Q1 in parallel on an equivalent circuit. The drain of switch Q1 is connected to input/output terminal t1, and the source of switch Q1 is connected to the drain of switch Q2.

Switch Q2 is, for example, an N-channel MOSFET. In FIG. 1, the parasitic capacity of switch Q2 is indicated by capacitor C2, and capacitor C2 is connected to switch Q2 in parallel on an equivalent circuit. The drain of switch Q2 is connected to the source of switch Q1, and the source of switch Q2 is connected to input/output terminal t2.

Switch Q3 is, for example, an N-channel MOSFET. In FIG. 1, the parasitic capacity of switch Q3 is indicated by capacitor C3, and capacitor C3 is connected to switch Q3 in parallel on an equivalent circuit. The drain of switch Q3 is connected to input/output terminal t1, and the source of switch Q3 is connected to the drain of switch Q4.

Switch Q4 is, for example, an N-channel MOSFET. In FIG. 1, the parasitic capacity of switch Q4 is indicated by capacitor C4, and capacitor C4 is connected to switch Q4 in parallel on an equivalent circuit. The drain of switch Q4 is connected to the source of switch Q3, and the source of switch Q4 is connected to input/output terminal t2.

Inductor L1 is provided on path P2 connecting input/output terminal t3 and connection node N1 between switch Q1 and switch Q2 on path P1. Connection node N1 is one example of a first node. Path P2 is one example of a second path. Inductor L2 is provided on path P4 connecting input/output terminal t3 and connection node N2 between switch Q3 and switch Q4 on path P3. Connection node N2 is one example of a second node. Path P4 is one example of a fourth path.

Drive circuit D1 is a circuit for driving switch Q1. Drive circuit D1 is, for example, a gate driver, and is connected to the gate of switch Q1. Drive circuit D2 is a circuit for driving switch Q2. Drive circuit D2 is, for example, a gate driver, and is connected to the gate of switch Q2. Drive circuit D3 is a circuit for driving switch Q3. Drive circuit D3 is, for example, a gate driver, and is connected to the gate of switch Q3. Drive circuit D4 is a circuit for driving switch Q4. Drive circuit D4 is, for example, a gate driver, and is connected to the gate of switch Q4.

In FIG. 1, the illustration of a power supply for operating drive circuits D1 and D2 is omitted. Drive circuit D3 is connected to BS circuit BS1. BS circuit BS1 is one example of a first bootstrap circuit. Like switches Q3 and Q4, a BS circuit may be used for a circuit having a half-bridge configuration, to ensure a drive voltage to the gate driver of a switch on the High side. BS circuit BS1 includes diode D10, bootstrap capacitor (BS capacitor) C10, and resistance R10. Since the drive voltage of drive circuit D3 of switch Q3 on the High side can be ensured by BS circuit BS1 having a simple circuit configuration including diode D10, BS capacitor C10, and resistance R10, cost and size can be reduced more than when an insulating DCDC module is used.

One end of BS capacitor C10 is connected to connection node N2 and the grand terminal of drive circuit D3, and the other end of BS capacitor C10 is connected to the power supply terminal of drive circuit D3 and one end of resistance R10. One end of resistance R10 is connected to the power supply terminal of drive circuit D3 and the other end of BS capacitor C10, and the other end of resistance R10 is connected to the cathode of diode D10. The anode of diode D10 is connected to power supply Vdd and the cathode of diode D10 is connected to the other end of resistance R10. The drive voltage of drive circuit D4 is supplied from power supply Vdd.

Since BS capacitor C10 is connected to the power supply terminal and the grand terminal of drive circuit D3, the charge voltage of BS capacitor C10 serves as a voltage for controlling the drive voltage of drive circuit D3, i.e., switch Q3. Charging of BS capacitor C10 is started when the voltage at one end of BS capacitor C10 (i.e., the voltage of connection node N2) is less than a value (referred to as a charge threshold) resulting from subtracting the forward voltage of diode D10 and the voltage of BS capacitor C10 from the voltage of power supply Vdd. It should be noted that the voltage of connection node N2 means the voltage between connection node N2 and input/output terminal t2.

Voltage detection circuit 110 is a circuit for detecting the voltage of connection node N2. The voltage detected by voltage detection circuit 110 is input to control circuit 100.

Control circuit 100 is a circuit for controlling switching (on and off) of switches (e.g., switches Q1, Q2, Q3, and Q4) included in power conversion device 10. Control circuit 100 is, for example, a micro controller unit (MCU). Control circuit 100 controls drive circuits D1, D2, D3, and D4 to control the switching of switches Q1, Q2, Q3, and Q4. It should be noted that in FIG. 1, the illustration of control lines connecting control circuit 100 and drive circuits D1, D2, D3, and D4 is omitted.

In the single-phase operation of power conversion device 10 (the details will be described later), control circuit 100 controls turn-off and turn-on of switch Q1 in accordance with a voltage detected by voltage detection circuit 110 (i.e., the voltage of connection node N2). It should be noted that turn-off is turning off a switch from its on-state, and turn-on is turning on a switch from its off-state.

It should be noted that power conversion device 10 may not include drive circuits D1, D2, D3, and D4, voltage detection circuit 110, and control circuit 100, and may be controlled by these components provided outside power conversion device 10.

Although power conversion device 10 is configured by two-phase circuits for obtaining high output, single-phase operation is performed at low output since efficiency decreases when two-phase operation is performed at low output. Single-phase operation is an operation of turning on and off switches Q1 and Q2 which is performed when switches Q3 and Q4 are in an off-state. Two-phase operation is an operation of turning on and off switches Q1, Q2, Q3, and Q4.

In a buck converter having an interleaved configuration in multiple phases that is at least two phases, efficiency at low output decreases due to an influence caused by a loss, such as a core loss, which does not depend on a current amount. For this reason, single-phase operation may be performed at low output and the operation shifts to two-phase operation at a point in time when output increases to a certain level. The operation of the second-phase circuit can be easily achieved by using, for the gate signal of the second-phase circuit (e.g., switches Q3 and Q4), a phase obtained by shifting the gate signal of the first-phase circuit (e.g., switches Q1 and Q2) by a half cycle.

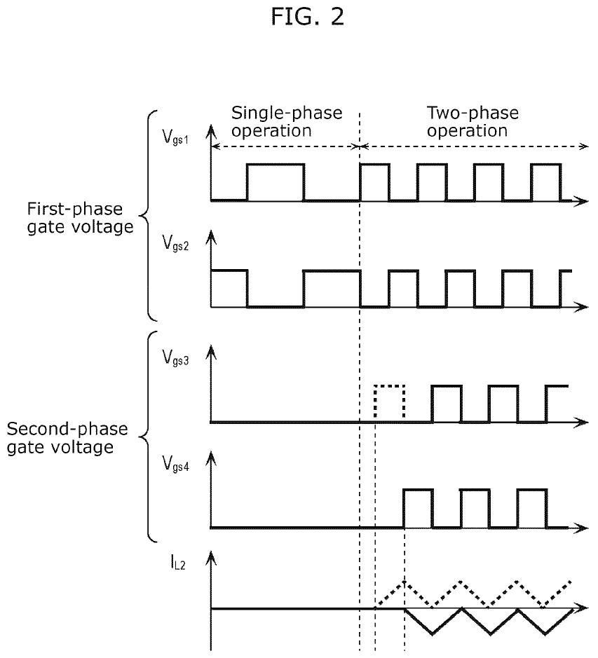

By thus switching between the single-phase operation and the two-phase operation while using a BS circuit BS1, it is possible to achieve highly-efficient power conversion device 10 in a wide power range while reducing cost and size. In a buck converter, however, a BS capacitor for driving a switch on the High side of the second-phase circuit may not be charged in single-phase operation. This is because the BS capacitor for driving a switch on the High side of the second-phase circuit is charged by a potential difference being generated between sides of the BS capacitor, but both of the switch on the High side and the switch on the Low side of the second-phase circuit are in an off-state and charges are not accumulated in the BS capacitor. Then, there is a problem that the second-phase circuit cannot operate normally when single-phase operation is switched to two-phase operation in a state that the BS capacitor is not charged. This will be described with reference to FIG. 2.

FIG. 2 is a diagram for illustrating that the second-phase circuit cannot operate normally when switching to two-phase operation is performed in a state in which inductor L1 is not magnetically coupled to inductor L2. FIG. 2 illustrates, from top, the gate voltage (Vgs1) of a switch on the High side of the first-phase circuit, the gate voltage (Vgs2) of a switch on the Low side of the first-phase circuit, the gate voltage (Vgs3) of a switch on the High side of the second-phase circuit, the gate voltage (Vgs4) of a switch on the Low side of the second-phase circuit, and a current (IL2) that flows through the inductor of the second-phase circuit.

Since a BS capacitor for driving a switch on the High side of the second-phase circuit is not charged at the start of the two-phase operation, the gate voltage of the switch on the High side of the second-phase circuit is not output, as illustrated by the dotted line in the graph of Vgs3 in FIG. 2. Subsequently, when a switch on the Low side of the second-phase circuit is turned on, the BS capacitor is charged and the switch on the High side of the second-phase circuit can be driven thereafter. However, when a second-phase circuit in the buck converter starts operating from the switch on the Low side, the converter operates like a boost converter when viewed from the output side. Accordingly, the current as shown by the dotted line in the graph of IL2 in FIG. 2 does not flow, and current flows reversely from the output side to the input side, as shown by the solid line in the graph of IL2 in FIG. 2. As a result, an anomaly, such that the current of the first-phase circuit increases excessively and transitionally to compensate for the reverse flow, occurs, and this may lead to a circuit breakdown in some cases.

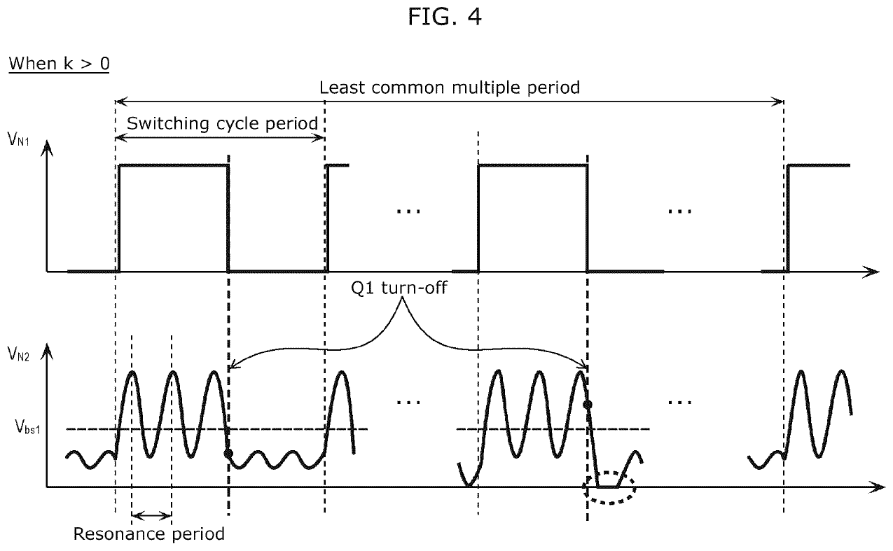

In view of this, the present disclosure can solve the above problem by magnetically coupling inductor L1 and inductor L2 to each other and also adjusting the timing of turning off or turning on switch Q1 in single-phase operation. FIG. 1 illustrates an example in which inductor L1 and inductor L2 are magnetically coupled by a positive coupling coefficient. In FIG. 4 to FIG. 6 and FIG. 8 to FIG. 11, k denotes a coupling coefficient.

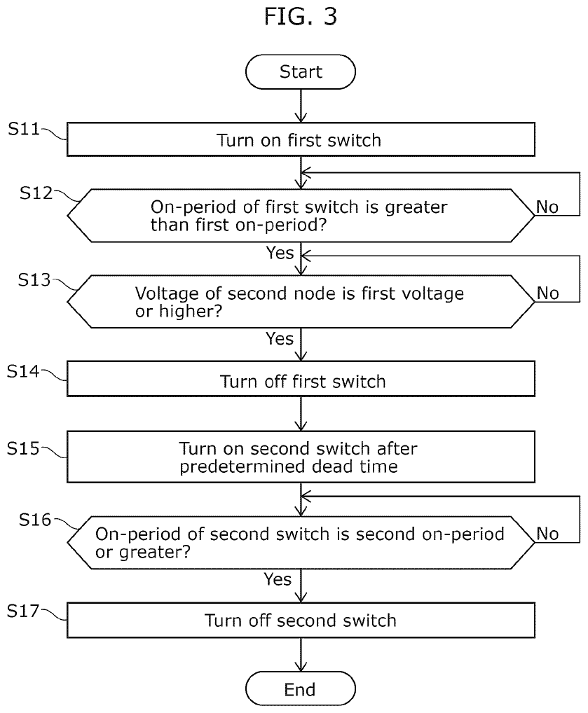

Next, an example of the operation of power conversion device 10 (specifically, control circuit 100) when inductor L1 and inductor L2 are magnetically coupled by a positive coupling coefficient will be described with reference to FIG. 3 and FIG. 4.

FIG. 3 is a flowchart illustrating one example of the operation of power conversion device 10 according to the embodiment. FIG. 3 illustrates the operation of power conversion device 10 when switches Q3 and Q4 are in an off-state and power conversion device 10 performs single-phase operation by turning on and off switches Q1 and Q2, and specifically illustrates an operation for charging BS capacitor C10 during the single-phase operation. It is assumed that inductor L1 and inductor L2 are magnetically coupled by a positive coupling coefficient.

FIG. 4 is a diagram for illustrating one example of switching conditions of switch Q1 for charging BS capacitor C10 when a coupling coefficient is positive. Voltage (V_{N1}) of connection node N1 in single-phase operation is shown on the upper side in FIG. 4, and voltage (V_{N2}) of connection node N2 in single-phase operation is shown on the lower side in FIG. 4. In single-phase operation, it is controlled so that switch Q2 is in an off-state when switch Q1 is in an on-state, and switch Q2 is in an on-state when switch Q1 is in an off-state. For this reason, in FIG. 4, when the voltage of connection node N1 is High, switch Q1 is in an on-state and switch Q2 is in an off-state, and when the voltage of connection node N1 is Low, switch Q1 is in an off-state and switch Q2 is in an on-state.

First, control circuit 100 turns on switch Q1 (the first switch) (step S11). Since inductor L2 is magnetically coupled to inductor L1, induced electromotive force is generated in inductor L2 due to a voltage applied to inductor L1 when power conversion device 10 performs single-phase operation. This inducted electromotive force is the voltage of connection node N2 and resonates during the single-phase operation, as illustrated in FIG. 4.

Subsequently, control circuit 100 determines whether the on-period of switch Q1 (the first switch) is greater than a first on-period (step S12). The first on-period is the shortest on-period necessary for obtaining desired output while maintaining zero voltage switching (ZVS). When the on-period of switch Q1 is turned off while the on-period of switch Q1 is less than the first on-period, the process in step S12 is performed since ZVS cannot be maintained and a loss occurs, and also, desired output cannot be obtained.

When determining that the on-period of switch Q1 is the first on-period or less (No in step S12), control circuit 100 repeats the process in step S12 until the on-period of switch Q1 is greater than the first on-period. In other words, control circuit 100 keeps the on-state of switch Q1 until the on-period of switch Q1 is greater than the first on-period.

When determining that the on-period of switch Q1 is greater than the first on-period (Yes in step S12), control circuit 100 determines whether the voltage of connection node N2 (a second node) is a first voltage or higher (step S13). The first voltage is determined based on a coupling coefficient and the voltage of input/output terminal t3. Specifically, the first voltage is in a proportional relationship with the coupling coefficient and the voltage of input/output terminal t3. More specifically, the inventors have discovered that it is good to set the first voltage to 2×(1−k)×Vₒᵤₜ−Vₜₕ, where k denotes a coupling coefficient, Vₒᵤₜ denotes the voltage of input/output terminal t3, and Vₜₕ denotes the voltage of connection node N2 (charge threshold) with which charging of BS capacitor C10 is started. In FIG. 4, V_{bs1} denotes the first voltage.

When determining that the voltage of connection node N2 is lower than the first voltage (No in step S13), control circuit 100 repeats the process in step S13 until the voltage of connection node N2 is the first voltage or higher. In other words, control circuit 100 keeps the on-state of switch Q1 until the voltage of connection node N2 is the first voltage or higher.

When determining that the voltage of connection node N2 is the first voltage or higher (Yes in step S13), control circuit 100 turns off switch Q1 (the first switch) (step S14).

The voltage of connection node N2 when inductor L1 and inductor L2 are magnetically coupled to each other by a positive coupling coefficient decreases when switch Q1 is turned off, and decreases greatly when switch Q1 is turned off particularly at the timing when the voltage of connection node N2 is high. As shown on the left side in FIG. 4, in the case where switch Q1 is turned off when the voltage of connection node N2 is lower than the first voltage, the voltage of connection node N2 does not decrease so much and it is difficult for the voltage of connection node N2 to go below a charge threshold. As shown at the center in FIG. 4, in the case where switch Q1 is turned off when the voltage of connection node N2 is the first voltage or higher, the voltage of connection node N2 decreases greatly and goes below the charge threshold. The dotted circle in the graph on the lower side in FIG. 4 shows that the voltage of connection node N2 goes below the charge threshold.

Control circuit 100 then turns on switch Q2 (the second switch) after a predetermined dead time (step S15). When the voltage at both ends of switch Q2 approaches 0V at the predetermined dead time and switch Q2 is turned on after the predetermined dead time, a turn-on loss can be reduced.

Subsequently, control circuit 100 determines whether the on-period of switch Q2 (the second switch) is a second on-period or greater (step S16). The second on-period is the shortest on-period necessary for normal operation and is determined based on the on-period of switch Q1, the voltage of input/output terminal t1, and the voltage of input/output terminal t3. The second on period is Tₒₙ₁×(Vᵢₙ−Vₒᵤₜ)/Vₒᵤₜ, where Tₒₙ₁ denotes the first on-period, Vᵢₙ denotes the voltage of input/output terminal t1, and Vₒᵤₜ denotes the voltage of input/output terminal t3.

When determining that the on-period of switch Q2 is less than the second on-period (No in step S16), control circuit 100 repeats the process in step S16 until the on-period of switch Q2 is the second on-period or greater. In other words, control circuit 100 keeps the on-state of switch Q2 until the on-period of switch Q2 is the second on-period or greater.

When determining that the on-period of switch Q2 is the second on-period or greater (Yes in step S16), control circuit 100 turns off switch Q2 (the second switch) (step S17). When recharging BS capacitor C10, control circuit 100 performs again processes from step S11.

Thus, when switches Q3 and Q4 are in an off-state and power conversion device 10 performs single-phase operation by turning on and off switches Q1 and Q2, BS capacitor C10 is charged by turning off switch Q1 from an on-state at the timing when the voltage of connection node N2 is the first voltage or higher. The voltage of connection node N2 resonates since the phases of indictor L1 and inductor L2 are magnetically coupled to each other, and BS capacitor C10 can be charged since the first-phase circuit operates so that the voltage of connection node N2 instantaneously goes below the charge threshold.

For example, charging of BS capacitor C10 (specifically, turning off switch Q1 from an on-state at the timing when the voltage of connection node N2 is the first voltage or higher) is performed at least once for each period that is the least common multiple of (i) a resonance period determined based on the inductances of inductors L1 and L2 as well as the parasitic capacity (capacitor C3) of switch Q3, and (ii) a switching cycle period when power conversion device 10 performs single-phase operation, as illustrated in FIG. 4. Thus, by charging BS capacitor C10 at least once for each period that is the least common multiple, it is possible to inhibit the charge voltage of BS capacitor C10 from decreasing to be lower than a voltage for operating switch Q3 normally.

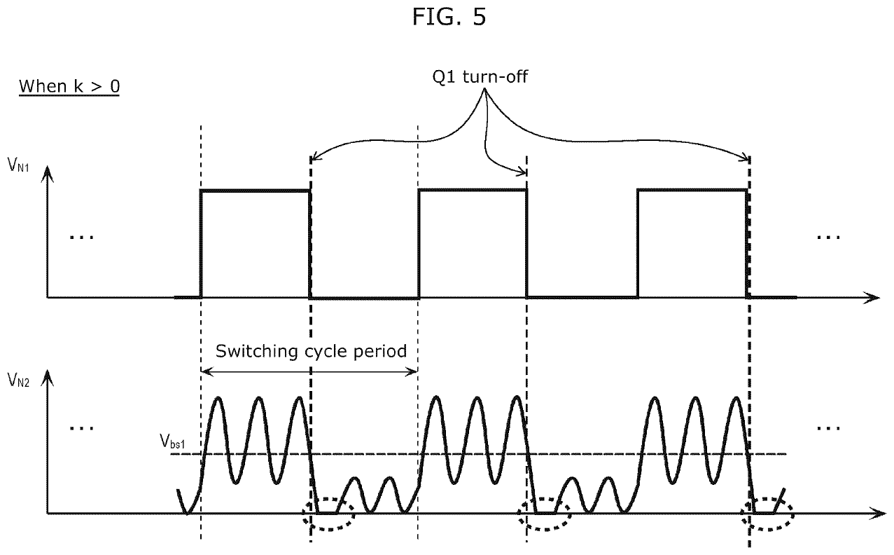

FIG. 5 is a diagram for illustrating another example of the charging timing of BS capacitor C10 when a coupling coefficient is positive. The voltage (V_{N1}) of connection node N1 in single-phase operation is shown on the upper side in FIG. 5, and the voltage (V_{N2}) of connection node N2 in single-phase operation is shown on the lower side in FIG. 5.

As illustrated in FIG. 5, charging of BS capacitor C10 can be performed for each switching cycle period. The dotted circle shown in the graph on the lower side in FIG. 5 indicates that the voltage of connection node N2 goes below the charge threshold. By charging BS capacitor C10 for each switching cycle period, it is possible to further inhibit the charge voltage of BS capacitor C10 from decreasing to be lower than a voltage for operating switch Q3 normally.

It should be noted that the charging of BS capacitor C10 in single-phase operation may be performed at random timing.

Next, an implementation method of control for turning off switch Q1 to charge BS capacitor C10 will be described.

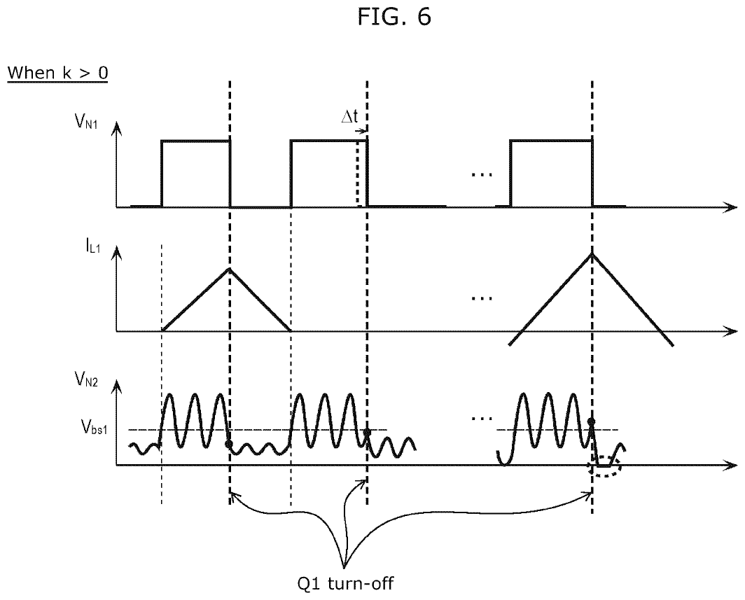

For example, a frequency allowed for each Duty cycle may be specified in advance and an on-period and an off-period of switch Q1 may be determined by a dataset related to the correspondence between the Duty cycle and the frequency. For example, the on-period and the off-period of switch Q1 may be determined dynamically depending on the situation. This will be described with reference to FIG. 6.

FIG. 6 is a diagram for illustrating one example of the adjustment of an on-period and an off-period of switch Q1. FIG. 6 illustrates, from top, the voltage (V_{N1}) of connection node N1 in single-phase operation, a current (I_{L1}) that flows through inductor L1, and the voltage (V_{N2}) of connection node N2 in single-phase operation.

As shown on the left side in FIG. 6, in the case where the voltage of connection node N2 does not go below a charge threshold and charging of BS capacitor C10 is not performed when switch Q1 is turned off, the next on-period of switch Q1 is extended by a predetermined time (Δₜ) than the previous on-period so that the average current of inductor L1 is maintained. The off-period of switch Q1 is likewise extended so that ZVS is performed. By continuously making this adjustment, the voltage of connection node N2 when switch Q1 is turned off gradually increases, and sooner or later, becomes the first voltage or higher. The dotted circle in the graph of the voltage of connection node N2 in FIG. 6 shows that the voltage of connection node N2 goes below the charge threshold, and it is apparent that BS capacitor C10 can be charged.

Thus, when charging of BS capacitor C10 is not performed, the on-period and the off-period of switch Q1 may be adjusted so that charging BS capacitor C10 is performed.

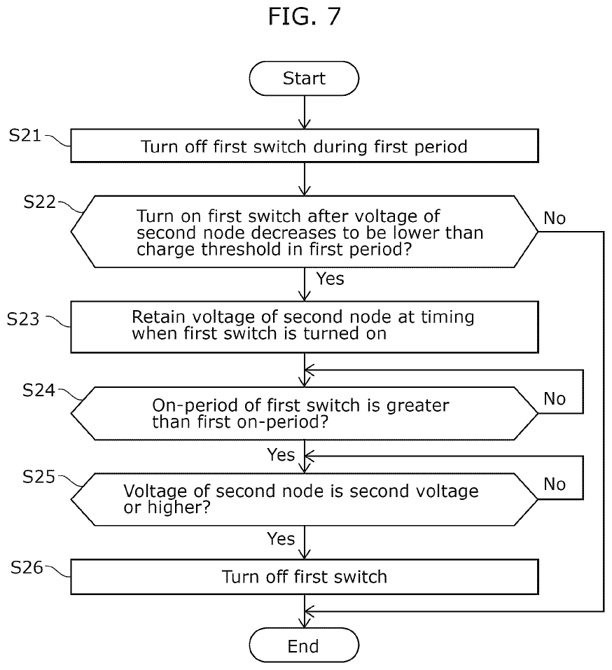

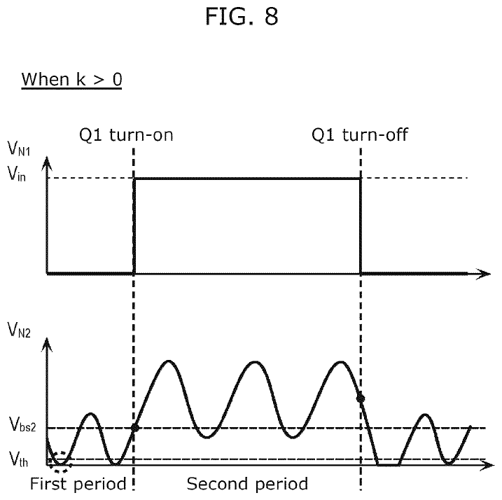

Next, another example of the operation of power conversion device 10 (specifically, control circuit 100) when inductor L1 and inductor L2 are magnetically coupled to each other by a positive coupling coefficient will be described with reference to FIG. 7 and FIG. 8.

FIG. 7 is a flowchart illustrating another example of the operation of power conversion device 10 according to the embodiment. FIG. 7 illustrates the operation of power conversion device 10 when switches Q3 and Q4 are in an off-state and power conversion device 10 performs single-phase operation by turning on and off switches Q1 and Q2, and specifically illustrates an operation for charging BS capacitor C10 in the single-phase operation. It is assumed that inductor L1 and inductor L2 are magnetically coupled to each other by a positive coupling coefficient.

FIG. 8 is a diagram for illustrating another example of the switching conditions of switch Q1 for charging BS capacitor C10 when a coupling coefficient is positive. The voltage (V_{N1}) of connection node N1 in single-phase operation is illustrated on the upper side in FIG. 8, and the voltage (V_{N2}) of connection node N2 in single-phase operation is illustrated on the lower side in FIG. 8. In single-phase operation, it is controlled so that switch Q2 is in an off-state when switch Q1 is in an on-state, and switch Q2 is in an on-state when switch Q1 is in an off-state. For this reason, in FIG. 8, when the voltage of connection node N1 is High, switch Q1 is in an on-state and switch Q2 is in an off-state, and when the voltage of connection node N1 is Low, switch Q1 is in an off-state and switch Q2 is in an on-state. FIG. 8 also illustrates a first period in a given switching cycle and a second period that follows the first period.

First, control circuit 100 brings switch Q1 (the first switch) to an off-state during a first period (step S21).

Subsequently, after the voltage of connection node N2 (the second node) decreases to be lower than the charge threshold in the first period, control circuit 100 determines whether switch Q1 (the first switch) is turned on (step S22). The dotted circle in the graph on the lower side in FIG. 8 illustrates that the voltage of connection node N2 is lower than the charge threshold (Vₜₕ). In other words, FIG. 8 illustrates an example in which switch Q1 is turned on after the voltage of connection node N2 is lower than the charge threshold in the first period.

When the voltage of connection node N2 does not decrease to be lower than the charge threshold in the first period and switch Q1 is turned on (No in step S22), control circuit 100 ends an operation for charging BS capacitor C10 and performs normal switching operation.

When switch Q1 is turned on after the voltage of connection node N2 decreases to be lower than the charge threshold in the first period (Yes in step S22), control circuit 100 retains the voltage of connection node N2 (the second node) at the timing when switch Q1 is turned on (step S23). In FIG. 8, V_{bs2} denotes the voltage of connection node N2 at the timing when switch Q1 is turned on.

Subsequently, control circuit 100 determines whether the on-period of switch Q1 (the first switch) is greater than a first on-period (step S24). The first on-period is the shortest on-period necessary for obtaining desired output while maintaining ZVS.

When determining that the on-period of switch Q1 is the first on-period or less (No in step S24), control circuit 100 repeats the process in step S24 until the on-period of switch Q1 is greater than the first on-period. In other words, control circuit 100 keeps the on-state of switch Q1 until the on-period of switch Q1 is greater than the first on-period.

When determining that the on-period of switch Q1 is greater than the first on-period (Yes in step S24), control circuit 100 determines whether the voltage of connection node N2 (the second node) is a second voltage or higher (step S25). The second voltage is the voltage retained in step S23. Specifically, the second voltage is the voltage of connection node N2 (V_{bs2} in FIG. 8) at the timing when switch Q1 is turned on from an off-state in the first period to an on-state in the second period in the case where the voltage of connection node N2 decreases to be lower than a voltage (charge threshold) with which charging of BS capacitor C10 is started when switch Q1 is in the off-state in the first period.

When determining that the voltage of connection node N2 is lower than the second voltage (No in step S25), control circuit 100 repeats the process in step S25 until the voltage of connection node N2 is the second voltage or higher. In other words, control circuit 100 keeps the on-state of switch Q1 until the voltage of connection node N2 is the second voltage or higher.

When determining that the voltage of connection node N2 is the second voltage or higher (Yes in step S25), control circuit 100 turns off switch Q1 (the first switch) (step S26).

The voltage of connection node N2 when inductor L1 and inductor L2 are magnetically coupled to each other by a positive coupling coefficient decreases when switch Q1 is turned off, and decreases greatly when switch Q1 is turned off particularly at the timing when the voltage of connection node N2 is high. As illustrated in FIG. 8, in the case where switch Q1 is turned off when the voltage of connection node N2 is the second voltage or higher, the voltage of connection node N2 decreases greatly and goes below the charge threshold.

Hereinafter, the same processes as those in steps S15 to S17 described with reference to FIG. 3 will be performed.

It should be noted that since the same processes as the processes in steps S25 and S26 can be performed by calculations performed by control circuit 100 and reference to a dataset, retaining or directly detecting, by voltage detection circuit 110, the voltage of connection node N2 at the timing when switch Q1 is turned on is not indispensable.

Thus, when switch Q1 is in an off-state in a first period in a given switching cycle, and is in an on-state in a second period that follows the first period, switches Q3 and Q4 are in an off-state, and power conversion device 10 performs single-phase operation by turning on and off switches Q1 and Q2, BS capacitor C10 is charged by turning off switch Q1 from the on-state in the second period at the timing when the voltage of connection node N2 is the second voltage or higher. The voltage of connection node N2 resonates since the phases of indictor L1 and inductor L2 are magnetically coupled to each other, and BS capacitor C10 can be charged by operating the first-phase circuit so that the voltage of connection node N2 instantaneously goes below the charge threshold.

For example, charging of BS capacitor C10 (specifically, turning off switch Q1 from an on-state at the timing when the voltage of connection node N2 is a second voltage or higher in the second period when the voltage of connection node N2 goes below the charge threshold in the first period) may be performed at least once for each period that is the least common multiple of (i) a resonance period determined based on the inductances of inductors L1 and L2 as well as the parasitic capacity (capacitor C3) of switch Q3, and (ii) a switching cycle period when power conversion device 10 performs single-phase operation. Charging of BS capacitor C10 may be performed for each switching cycle period. It should be noted that the charging of BS capacitor C10 in single-phase operation may be performed at random timing.

In an implementation method of control for turning off switch Q1 to charge BS capacitor C10, a frequency allowed for each Duty cycle may be specified in advance and an on-period and an off-period of switch Q1 may be determined by a dataset related to the correspondence between the Duty cycle and the frequency. Alternatively, when charging of BS capacitor C10 is not performed, the on-period and the off-period of switch Q1 may be adjusted so that charging of BS capacitor C10 is performed.

As described above, by magnetically coupling inductor L1 and inductor L2 to each other by a positive coupling coefficient and adjusting the timing of turning off switch Q1 based on the voltage of connection node N2 in single-phase operation, BS capacitor C10 can be charged without using, for instance, an isolated power supply or performing precharge operation. Accordingly, it is possible to provide power conversion device 10 that uses BS circuit BS1 capable of reducing cost and size while inhibiting control complications.

The timing of turning off switch Q1 for charging BS capacitor C10 in single-phase operation when a coupling coefficient is positive has been described, but BS capacitor C10 can be charged irrespective of the switching of switch Q1 by designing a coupling coefficient to be a specific value. Hereinafter, coupling coefficient conditions for charging BS capacitor C10 irrespective of the switching of switch Q1 will be described.

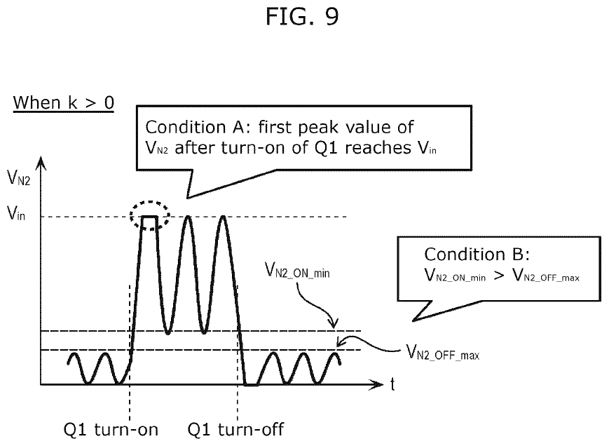

FIG. 9 is a diagram for illustrating one example of coupling coefficient conditions for charging BS capacitor C10 irrespective of the switching of switch Q1 when a coupling coefficient is positive. FIG. 9 shows the voltage (V_{N2}) of connection node N2 in single-phase operation. Vᵢₙ shown in FIG. 9 is the voltage of input/output terminal t1, V_{N2}_ON_min is the minimum value of the voltage of connection node N2 that is resonating when switch Q1 is in an on-state, and V_{N2}_OFF_max is the maximum value of the voltage of connection node N2 that is resonating when switch Q1 is in an off-state.

If a coupling coefficient is designed to constantly satisfy condition A and condition B shown in FIG. 9, BS capacitor C10 can be charged irrespective of the switching of switch Q1. If condition A is expressed by a mathematical expression, the expression is Vₒᵤₜ+k (Vᵢₙ−Vₒᵤₜ)>Vᵢₙ/2. If condition B is expressed by a mathematical expression, the expression is 2×(Vₒᵤₜ−kVₒᵤₜ)−Vₜₕ<Vᵢₙ−2×[Vᵢₙ−{Vₒᵤₜ+k(Vᵢₙ−Vₒᵤₜ)}]. It should be noted that Vₒᵤₜ denotes the voltage of input/output terminal t3, k denotes a coupling coefficient, Vᵢₙ denotes the voltage of input/output terminal t1, and Vₜₕ denotes a charge threshold. If these expressions are sorted out, k>½−Vₜₕ/2Vᵢₙ holds true. In other words, when a coupling coefficient is positive, by designing power conversion device 10 to increase the coupling coefficient to be greater than 0.5−Vₜₕ/2Vᵢₙ, BS capacitor C10 can be charged irrespective of the switching timing of switch Q1 in single-phase operation.

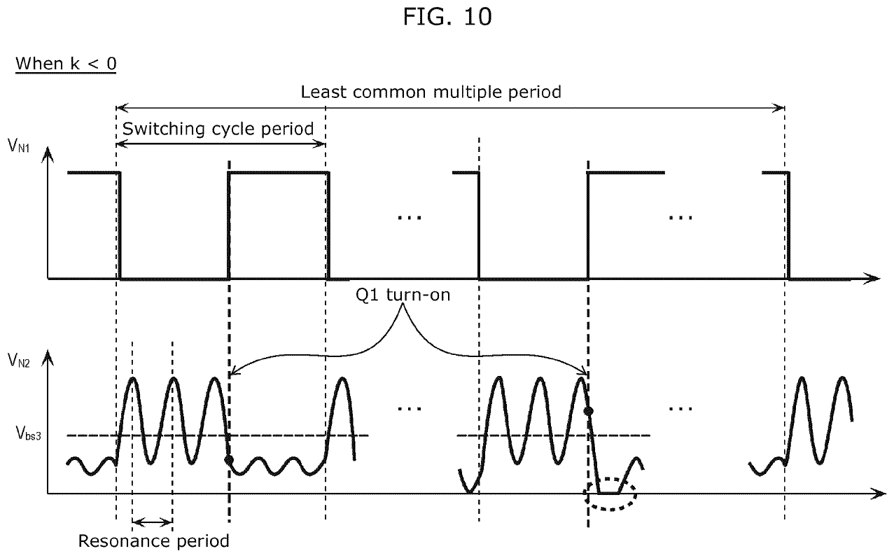

Next, an example of the operation of power conversion device 10 (specifically, control circuit 100) when inductor L1 and inductor L2 are magnetically coupled to each other by a negative coupling coefficient will be described with reference to FIG. 10.

FIG. 10 is a diagram for illustrating one example of switching conditions of switch Q1 for charging BS capacitor C10 when a coupling coefficient is negative. The voltage (V_{N1}) of connection node N1 in single-phase operation is shown on the upper side in FIG. 10, and the voltage (V_{N2}) of connection node N2 in single-phase operation is shown on the lower side in FIG. 10. In single-phase operation, it is controlled so that switch Q2 is in an off-state when switch Q1 is in an on-state, and is in an on-state when switch Q1 is in an off-state. For this reason, in FIG. 10, when the voltage of connection node N1 is High, switch Q1 is in an on-state and switch Q2 is in an off-state, and when the voltage of connection node N1 is Low, switch Q1 is in an off-state and switch Q2 is in an on-state.

Since inductor L2 is magnetically coupled to inductor L1, induced electromotive force is generated in inductor L2 due to a voltage applied to inductor L1 when power conversion device 10 performs single-phase operation. This induced electromotive force is the voltage of connection node N2 and resonates in the single-phase operation, as illustrated in FIG. 10.

Control circuit 100 determines whether the voltage of connection node N2 is a third voltage or higher when switch Q1 is in an off-state in single-phase operation. The third voltage is determined based on a coupling coefficient, the voltage of input/output terminal t1, and the voltage of input/output terminal t3. Specifically, the third voltage is in a proportional relationship with a coupling coefficient, the voltage of input/output terminal t1, and the voltage of input/output terminal t3. More specifically, the inventors have discovered that it is good to set the third voltage to 2×{Vₒᵤₜ−|k|×(Vᵢₙ−Vₒᵤₜ)}−Vₜₕ where k denotes a coupling coefficient, Vᵢₙ denotes the voltage of input/output terminal t1, Vₒᵤₜ denotes the voltage of input/output terminal t3, and Vₜₕ denotes the voltage (charge threshold) of connection node N2 with which charging of BS capacitor C10 is started. In FIG. 10, V_{bs3} denotes the third voltage.

When determining that the voltage of connection node N2 is the third voltage or higher, control circuit 100 turns on switch Q1.

The voltage of connection node N2 when inductor L1 and inductor L2 are magnetically coupled to each other by a negative coupling coefficient decreases when switch Q1 is turned on, and decreases greatly when switch Q1 is turned on particularly at the timing when the voltage of connection node N2 is high. As shown on the left side in FIG. 10, in the case where switch Q1 is turned on when the voltage of connection node N2 is lower than the third voltage, the voltage of connection node N2 does not decrease so much and it is difficult for the voltage of connection node N2 to go below a charge threshold. As shown at the center in FIG. 10, in the case where switch Q1 is turned on when the voltage of connection node N2 is the third voltage or higher, the voltage of connection node N2 decreases greatly and goes below the charge threshold. The dotted circle in the graph on the lower side in FIG. 10 shows that the voltage of connection node N2 goes below the charge threshold.

Thus, when switches Q3 and Q4 are in an off-state and power conversion device 10 performs single-phase operation by turning on and off switches Q1 and Q2, BS capacitor C10 is charged by turning on switch Q1 from an off-state at the timing when the voltage of connection node N2 is the third voltage or higher. The voltage of connection node N2 resonates since the phases of indictor L1 and inductor L2 are magnetically coupled to each other, and BS capacitor C10 can be charged by operating the first-phase circuit so that the voltage of connection node N2 instantaneously goes below the charge threshold.

For example, charging of BS capacitor C10 (specifically, turning on switch Q1 from an off-state at the timing when the voltage of connection node N2 is the third voltage or higher) may be performed at least once for each period that is the least common multiple of (i) a resonance period determined based on the inductances of inductors L1 and L2 as well as the parasitic capacity (capacitor C3) of switch Q3, and (ii) a switching cycle period when power conversion device 10 performs single-phase operation. Charging of BS capacitor C10 may be performed for each switching cycle period. It should be noted that the charging of BS capacitor C10 in single-phase operation may be performed at random timing.

In an implementation method of control for turning on switch Q1 to charge BS capacitor C10, a frequency allowed for each Duty cycle may be specified in advance and an on-period and an off-period of switch Q1 may be determined by a dataset related to the correspondence between the Duty cycle and the frequency. Alternatively, when charging of BS capacitor C10 is not performed, the on-period and the off-period of switch Q1 may be adjusted so that charging of BS capacitor C10 is performed.

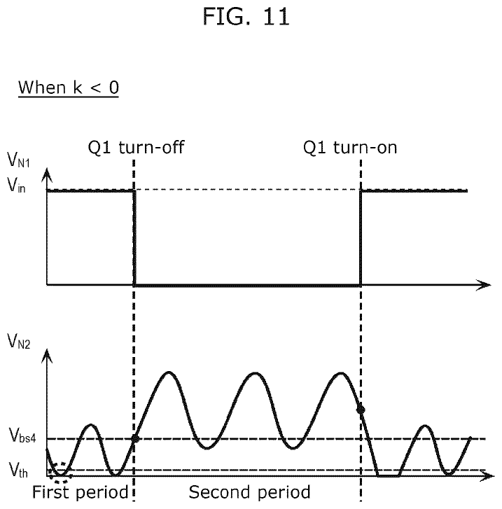

Next, another example of the operation of power conversion device 10 (specifically, control circuit 100) when inductor L1 and inductor L2 are magnetically coupled to each other by a negative coupling coefficient will be described with reference to FIG. 11.

FIG. 11 is a diagram for illustrating another example of the switching conditions of switch Q1 for charging BS capacitor C10 when a coupling coefficient is negative. The voltage (V_{N1}) of connection node N1 in single-phase operation is shown on the upper side in FIG. 11, and the voltage (V_{N2}) of connection node N2 in single-phase operation is shown on the lower side in FIG. 11. In single-phase operation, it is controlled so that switch Q2 is in an off-state when switch Q1 is in an on-state, and in an on-state when switch Q1 is in an off-state. For this reason, in FIG. 11, when the voltage of connection node N1 is High, switch Q1 is in an on-state and switch Q2 is in an off-state, and when the voltage of connection node N1 is Low, switch Q1 is in an off-state and switch Q2 is in an on-state. In FIG. 11, a first period and a second period that follows the first period in a given switching cycle are shown.

After the voltage of connection node N2 decreases to be lower than the charge threshold in the first period, control circuit 100 determines whether switch Q1 is turned off. The dotted circle in the graph on the lower side in FIG. 11 shows that the voltage of connection node N2 is lower than the charge threshold (Vₜₕ) in the first period. In other words, FIG. 11 illustrates an example in which switch Q1 is turned off after the voltage of connection node N2 becomes lower than the charge threshold in the first period.

When switch Q1 is turned off after the voltage of connection node N2 decreases to be lower than the charge threshold in the first period, control circuit 100 retains the voltage of connection node N2 at the timing when switch Q1 is turned off. In FIG. 11, V_{bs4} denotes the voltage of connection node N2 at the timing when switch Q1 is turned off.

Control circuit 100 determines whether the voltage of connection node N2 is a fourth voltage or higher. The fourth voltage is a retained voltage. Specifically, the fourth voltage is the voltage (V_{bs4} in FIG. 11) of connection node N2 at the timing when switch Q1 is turned off from an on-state in the first period to an off-state in the second period in the case where the voltage of connection node N2 decreases to be lower than a voltage (charge threshold) with which charging of BS capacitor C10 is started when switch Q1 is in an on-state in the first period.

When determining that the voltage of connection node N2 is the fourth voltage or higher, control circuit 100 turns on switch Q1.

The voltage of connection node N2 when inductor L1 and inductor L2 are magnetically coupled to each other by a negative coupling coefficient decreases when switch Q1 is turned on, and decreases greatly when switch Q1 is turned on particularly at the timing when the voltage of connection node N2 is high. As shown in FIG. 11, in the case where switch Q1 is turned on when the voltage of connection node N2 is the fourth voltage or higher, the voltage of connection node N2 decreases greatly and goes below the charge threshold.

Thus, when switch Q1 is in an on-state in a first period in a given switching cycle, and is in an off-state in a second period that follows the first period, switches Q3 and Q4 are in an off-state, and power conversion device 10 performs single-phase operation by turning on and off switches Q1 and Q2, BS capacitor C10 is charged by turning on switch Q1 from an off-state in the second period at the timing when the voltage of connection node N2 is the fourth voltage or higher. The voltage of connection node N2 resonates since the phases of indictor L1 and inductor L2 are magnetically coupled to each other, and BS capacitor C10 can be charged by operating the first-phase circuit so that the voltage of connection node N2 instantaneously goes below the charge threshold.

For example, charging of BS capacitor C10 (specifically, turning on switch Q1 from an off-state at the timing when the voltage of connection node N2 is the fourth voltage or higher in the second period when the voltage of connection node N2 goes below the charge threshold in the first period) may be performed at least once for each period that is the least common multiple of (i) a resonance period determined based on the inductances of inductors L1 and L2 as well as the parasitic capacity (capacitor C3) of switch Q3, and (ii) a switching cycle period when power conversion device 10 performs single-phase operation. Charging of BS capacitor C10 may be performed for each switching cycle period. It should be noted that the charging of BS capacitor C10 in single-phase operation may be performed at random timing.

In an implementation method of control for turning on switch Q1 to charge BS capacitor C10, a frequency allowed for each Duty cycle may be specified in advance and an on-period and an off-period of switch Q1 may be determined by a dataset related to the correspondence between the Duty cycle and the frequency. Alternatively, when charging of BS capacitor C10 is not performed, the on-period and the off-period of switch Q1 may be adjusted so that charging of BS capacitor C10 is performed.

As described above, by magnetically coupling inductor L1 and inductor L2 to each other by a negative coupling coefficient and adjusting the timing of turning on switch Q1 based on the voltage of connection node N2 in single-phase operation, BS capacitor C10 can be charged without using, for instance, an isolated power supply or performing precharge operation. Accordingly, it is possible to provide power conversion device 10 that uses BS circuit BS1 capable of reducing cost and size while inhibiting control complications.

The timing of turning on switch Q1 for charging BS capacitor C10 in single-phase operation when a coupling coefficient is negative has been described, but BS capacitor C10 can be charged irrespective of the switching of switch Q1 by designing a coupling coefficient to be a specific value. Hereinafter, coupling coefficient conditions for charging BS capacitor C10 irrespective of the switching of switch Q1 will be described.

When a coupling coefficient is negative, BS capacitor C10 can be charged irrespective of switching of switch Q1 by designing a coupling coefficient that constantly satisfies a condition that the voltage of connection node N2 that is resonating when switch Q1 is in an off-state in single-phase operation goes below 0V, i.e., 2×{Vₒᵤₜ−|k|×(Vᵢₙ−Vₒᵤₜ)}−Vₜₕ<0. It should be noted that Vₒᵤₜ denotes the voltage of input/output terminal t3, k denotes a coupling coefficient, Vᵢₙ denotes the voltage of input/output terminal t1, and Vₜₕ denotes a charge threshold. If these expressions are sorted out, |k|>(Vₒᵤₜ−Vₜₕ)/(Vᵢₙ−Vₒᵤₜ) holds true. In other words, when a coupling coefficient is negative, BS capacitor C10 can be charged irrespective of the switching timing of switch Q1 in single-phase operation by designing power conversion device 10 to increase the absolute value of the coupling coefficient to be greater than (Vₒᵤₜ−Vₜₕ/(Vᵢₙ−Vₒᵤₜ).

### Other Embodiments

As described above, the embodiment has been described as an example of techniques according to the present disclosure. The techniques according to the present disclosure, however, are not limited to this example and are applicable to an embodiment to which changes, replacement, addition, and omission are made where necessary. For example, variations as described below are included in embodiments of the present disclosure.

For example, the above embodiment has described two-phase power conversion device 10 capable of charging BS capacitor C10 in single-phase operation. Hereinafter, a power conversion device configured by three or more phases that is capable of charging a BS capacitor in single-phase operation will be described.

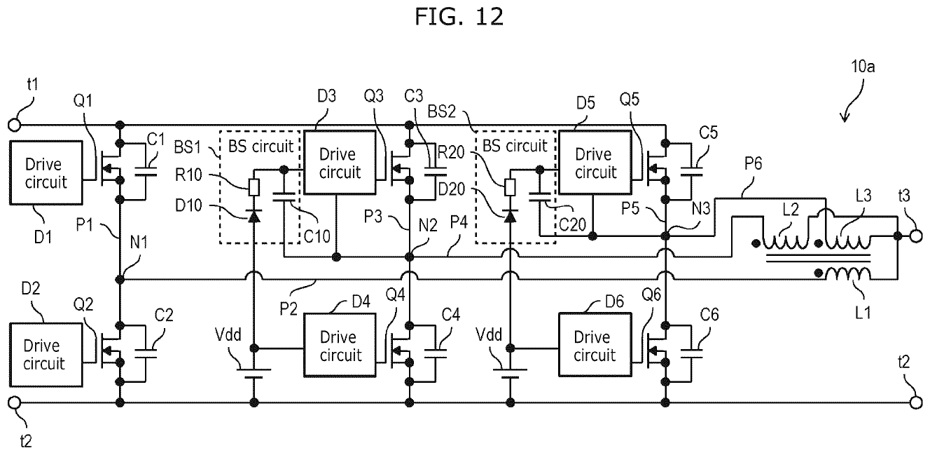

FIG. 12 is a configuration diagram illustrating one example of power conversion device 10a according to other embodiment.

Power conversion device 10a is different from power conversion device 10 according to the embodiment in regard to the additional inclusion of switches Q5 and Q6, inductor L3, drive circuits D5 and D6, and BS circuit BS2. In FIG. 12, the illustration of control circuit 100 and voltage detection circuit 110 is omitted. Since power conversion device 10a is basically the same as power conversion device 10 according to the embodiment regarding other points, the following focuses on the difference.

For example, power conversion device 10a is a three-phase power conversion device. Switches Q1 and Q2 as well as inductor L1 are first-phase circuits in three-phase power conversion device 10a. Switches Q3 and Q4 as well as inductor L2 are second-phase circuits in three-phase conversion device 10a. Switches Q5 and Q6 as well as inductor L3 are third-phase circuits in three-phase power conversion device 10a. In the case where power conversion device 10a is a power conversion device configured by three or more phases, power conversion device 10a includes, as a third-phase circuit or a lower-phase circuit, one or more circuits each including switches Q5 and Q6 as well as inductor L3.

Switch Q5 is one example of a fifth switch provided on path P5 that is different from path P1 and path P3, and connects input/output terminal t1 and input/output terminal t2. Path P5 is one example of a fifth path. Switch Q5 is a switch on the High side of a third-phase circuit. Switch Q6 is one example of a sixth switch provided on path P5 and connected to switch Q5 in series. Switch Q6 is a switch on the Low side of the third-phase circuit.

Switch Q5 is, for example, an N-channel MOSFET. FIG. 12 illustrates the parasitic capacity of switch Q5 by capacitor C5, and capacitor C5 is connected to switch Q5 in parallel on an equivalent circuit. The drain of switch Q5 is connected to input/output terminal t1, and the source of switch Q5 is connected to the drain of switch Q6.

Switch Q6 is, for example, an N-channel MOSFET. FIG. 12 illustrates the parasitic capacity of switch Q6 by capacitor C6, and capacitor C6 is connected to switch Q6 in parallel on an equivalent circuit. The drain of switch Q6 is connected to the source of switch Q5, and the source of switch Q6 is connected to input/output terminal t2.

Inductor L3 is provided on path P6 connecting input/output terminal t3 and connection node N3 between switch Q5 and switch Q6 on path P5. Connection node N3 is one example of a third node. Path P6 is one example of a sixth path. Inductor L1 is magnetically coupled to inductor L3. In other words, inductors L2 and L3 in a second-phase circuit or a lower-phase circuit are magnetically coupled to inductor L1 in the first-phase circuit. Although FIG. 12 illustrates an example in which inductor L1 is magnetically coupled to inductors L2 and L3 by a positive coupling coefficient, inductor L1 may be magnetically coupled to inductors L2 and L3 by a negative coupling coefficient.

Drive circuit D5 is a circuit for driving switch Q5. Drive circuit D5 is, for example, a gate driver and is connected to the gate of switch Q5. Drive circuit D6 is a circuit for driving switch Q6. Drive circuit D6 is, for example, a gate driver and is connected to the gate of switch Q6.

Drive circuit D5 is connected to BS circuit BS2. BS circuit BS2 is one example of a second bootstrap circuit. BS circuit BS2 includes diode D20, BS capacitor C20, and resistance R20.

One end of BS capacitor C20 is connected to connection node N3 and the ground terminal of drive circuit D5, and the other end of BS capacitor C20 is connected to the power supply terminal of drive circuit D5 and one end of resistance R20. One end of resistance R20 is connected to the power supply terminal of drive circuit D5 and the other end of BS capacitor C20, and the other end of resistance R20 is connected the cathode of diode D20. The anode of diode D20 is connected to power supply Vdd and the cathode of diode D20 is connected to the other end of resistance R20. The drive voltage of drive circuit D6 is supplied from power supply Vdd.

Since BS capacitor C20 is connected to the power supply terminal and the ground terminal of drive circuit D5, the charge voltage of BS capacitor C20 serves as the drive voltage of drive circuit D5, i.e., a voltage for controlling switch Q5. Charging of BS capacitor C20 is started when the voltage at one end of BS capacitor C20 (i.e., the voltage of connection node N3) is lower than a value (charge threshold) resulting from subtracting the forward voltage of diode D20 and the voltage of BS capacitor C20 from the voltage of power supply Vdd. The voltage of connection node N3 means the voltage between connection node N3 and input/output terminal t2.

Voltage detection circuit 110 in power conversion device 10a configured by three or more phases detects at least one of the voltage of connection node N2 and the voltage of connection node N3.

Control circuit 100 in power conversion device 10a configured by three or more phases controls switching (on and off) of switches (e.g., switches Q1, Q2, Q3, Q4, Q5, Q6) included in power conversion device 10a. Control circuit 100 controls drive circuits D1, D2, D3, D4, D5, and D6 to control the switching of switches Q1, Q2, Q3, Q4, Q5, and Q6.

Control circuit 100 also controls turning off or turning on switch Q1 in accordance with a voltage (i.e., at least one of the voltage of connection node N2 and the voltage of connection node N3) detected by voltage detection circuit 110 when power conversion device 10a is in simple-phase operation.

It should be noted that power conversion device 10a need not include drive circuits D1, D2, D3, D4, D5, and D6, voltage detection circuit 110, and control circuit 100, and power conversion device 10a may be controlled by these components provided outside power conversion device 10a.

In power conversion device 10a, BS capacitors C10 and C20 in BS circuits BS1 and BS2 are charged by turning off switch Q1 from an on-state or turning on switch Q1 from an off-state at the timing when at least one of the voltage of connection node N2 or the voltage of connection node N3 is a predetermined voltage or higher when switches Q3, Q4, Q5, and Q6 are in an off-state and power conversion device 10a performs single-phase operation by turning on and off switches Q1 and Q2. The predetermined voltage is the first voltage, the second voltage, the third voltage, or the fourth voltage described in the embodiment.

Thus, in power conversion device 10a configured by three or more phases, by magnetically coupling inductor L1 to inductors L2 and L3 and adjusting the timing of turning off or turning on switch Q1 based on the voltage of connection node N2 or the voltage of connection node N3 in single-phase operation, BS capacitors C10 and C20 in a second or lower-phase circuit can be charged without using, for instance, an isolated power supply and performing precharge operation.

For example, the present disclosure can be implemented not only as a power conversion device, but also as a power conversion device control method that includes steps (processes) performed by components (e.g., control circuit 100) included in the power conversion device.

For example, the steps in the control method may be executed by a computer (computer system). The present disclosure can be implemented as a program for causing the computer to execute the steps included in the control method.

Moreover, the present disclosure can be implemented as a non-transitory computer-readable recording medium such as a CD-ROM on which the program is recorded.

When the present disclosure is implemented by a program (software), each of the steps is executed by the program executed by utilizing hardware resources of, for instance, a CPU, memory, and an input/output circuit in the computer. In other words, each step is executed by the CPU obtaining or calculating data from, for instance, the memory or the input/output circuit, or outputting a calculation result to the memory or the input/output circuit.

Each of components included in the power conversion device according to the above embodiment may be implemented as a dedicated or general circuit.

Each of the components included in the power conversion device according to the above embodiment may be implemented as a large scale integration (LSI) circuit that is an integrated circuit (IC).

The components need not be implemented as LSIs but may be implemented as dedicated circuits or general-purpose processors. A field programmable gate array (FPGA) that can be programmed or a reconfigurable processor that can reconfigure the connection or configuration of circuit cells in the LSI may be used.

Furthermore, if other technologies that improve upon or are derived from semiconductor technology enable integration technology to replace LSI circuits, then naturally it is also possible to integrate the components included in the power conversion device using that technology.

Other embodiments obtained by various modifications to the embodiments which may be conceived by those skilled in the art, and embodiments achieved by combining elements and functions described in each of the embodiments are also included in the scope of the present disclosure so long as they do not depart from the essence of the present disclosure.

### (Supplementary Notes)

Based on the embodiments described above, the following techniques are disclosed.

(Technique 1) A power conversion device configured by n phases where n is an integer greater than or equal to 2, the power conversion device comprising:
a first switch provided on a first path connecting a first input/output terminal and a second input/output terminal;
a second switch provided on the first path and connected to the first switch in series;
a first inductor provided on a second path connecting a third input/output terminal and a first node between the first switch and the second switch on the first path;
a third switch provided on a third path connecting the first input/output terminal and the second input/output terminal, the third path being different from the first path;
a fourth switch provided on the third path and connected to the third switch in series;
a second inductor provided on a fourth path connecting the third input/output terminal and a second node between the third switch and the fourth switch on the third path; and
a first bootstrap circuit including a bootstrap capacitor whose one end is connected to the second node and whose other end is connected to a drive circuit for driving the third switch, wherein
the first inductor and the second inductor are magnetically coupled to each other by a positive coupling coefficient,
when the third switch and the fourth switch are in an off-state and the power conversion device performs single-phase operation by turning on and off the first switch and the second switch, the bootstrap capacitor is charged by turning off the first switch from an on-state at a timing when a voltage of the second node is a first voltage or higher, and
the first voltage is determined based on the positive coupling coefficient and a voltage of the third input/output terminal.

Since the second inductor is magnetically coupled to the first inductor, induced electromotive force is generated in the second inductor due to a voltage applied to the first inductor when the power conversion device performs single-phase operation. This induced electromotive force is the voltage of the second node and resonates in the single-phase operation. Since the voltage of the second node when the first inductor and the second inductor are magnetically coupled to each other by a positive coupling coefficient decreases when the first switch is turned off, and can be decreased greatly when the first switch is turned off particularly at the timing when the voltage of the second node is high, the voltage of the second node can be reduced greatly by adjusting the timing of turning off the first switch. Specifically, the voltage of the second node can be reduced greatly by turning off the first switch at the timing when the voltage of the second node is a first voltage or higher. The first voltage is determined based on the positive coupling coefficient and the voltage of the third input/output terminal. Since the voltage of the second node is the voltage at one end of the bootstrap capacitor, the potential difference between the ends of the bootstrap capacitor increases owing to a great fall in the voltage of the second node and the bootstrap capacitor can be charged. This enables the second-phase circuit (specifically, the third switch) to operate normally when single-phase operation is switched to multiple-phase operation.

Thus, by magnetically coupling the first inductor and the second inductor to each other by a positive coupling coefficient and adjusting the timing of turning off the first switch based on the voltage of the second node in single-phase operation, the bootstrap capacitor can be charged without using, for instance, an isolated power supply or performing precharge operation. Accordingly, it is possible to provide a power conversion device that uses bootstrap circuits capable of reducing cost and size while inhibiting control complications.

(Technique 2) The power conversion device according to Technique 1, wherein
the first voltage is in a proportional relationship with the positive coupling coefficient and the voltage of the third input/output terminal.

Thus, the bootstrap capacitor can be charged by turning off the first switch at the timing when the voltage of the second node is the first voltage or higher in single-phase operation. The first voltage is in a proportional relationship with the positive coupling coefficient and the voltage of the third input/output terminal.

(Technique 3) The power conversion device according to Technique 2, wherein
the first voltage is 2×(1−k)×Vₒᵤₜ−Vₜₕ, where k denotes the positive coupling coefficient, Vₒᵤₜ denotes the voltage of the third input/output terminal, and Vₜₕ denotes the voltage of the second node with which the charging of the bootstrap capacitor is started.

Thus, the bootstrap capacitor can be charged by turning off the first switch at the timing when the voltage of the second node is 2×(1−k)×Vₒᵤₜ−Vₜₕ or higher.

(Technique 4) A power conversion device configured by n phases where n is an integer greater than or equal to 2, the power conversion device comprising:
a first switch provided on a first path connecting a first input/output terminal and a second input/output terminal;
a second switch provided on the first path and connected to the first switch in series;
a first inductor provided on a second path connecting a third input/output terminal and a first node between the first switch and the second switch on the first path;
a third switch provided on a third path connecting the first input/output terminal and the second input/output terminal, the third path being different from the first path;
a fourth switch provided on the third path and connected to the third switch in series;
a second inductor provided on a fourth path connecting the third input/output terminal and a second node between the third switch and the fourth switch on the third path; and
a first bootstrap circuit including a bootstrap capacitor whose one end is connected to the second node and whose other end is connected to a drive circuit for driving the third switch, wherein
the first inductor and the second inductor are magnetically coupled to each other by a positive coupling coefficient,
the first switch is in an off-state in a first period in a given switching cycle, and is in an on-state in a second period that follows the first period,
when the third switch and the fourth switch are in an off-state and the power conversion device performs single-phase operation by turning on and off the first switch and the second switch, the bootstrap capacitor is charged by turning off the first switch from the on-state in the second period at a timing when a voltage of the second node is a second voltage or higher, and
the second voltage is the voltage of the second node at a timing when the first switch is turned on from the off-state in the first period to the on-state in the second period in a case where the voltage of the second node is lower than a voltage with which charging of the bootstrap capacitor is started when the first switch is in the off-state in the first period.

Since the second inductor is magnetically coupled to the first inductor, induced electromotive force is generated in the second inductor due to a voltage applied to the first inductor when the power conversion device performs single-phase operation. This induced electromotive force is the voltage of the second node and resonates in the single-phase operation. Since the voltage of the second node when the first inductor and the second inductor are magnetically coupled to each other by a positive coupling coefficient decreases when the first switch is turned off, and can be decreased greatly when the first switch is turned off particularly at the timing when the voltage of the second node is high, the voltage of the second node can be reduced greatly by adjusting the timing of turning off the first switch. Specifically, the voltage of the second node can be reduced greatly by turning off the first switch at the timing when the voltage of the second node is a second voltage (the voltage of the second node at the timing when the first switch is turned on after the voltage of the second node decreases to be lower than a voltage with which charging of the bootstrap capacitor is started when the first switch is in an off-state). Since the voltage of the second node is the voltage at one end of the bootstrap capacitor, the potential difference between the ends of the bootstrap capacitor increases owing to a great fall in the voltage of the second node and the bootstrap capacitor can be charged. This enables the second-phase circuit (specifically, the third switch) to operate normally when single-phase operation is switched to multiple-phase operation.

Thus, by magnetically coupling the first inductor and the second inductor to each other by a positive coupling coefficient and adjusting the timing of turning off the first switch based on the voltage of the second node in single-phase operation, the bootstrap capacitor can be charged without using, for instance, an isolated power supply or performing precharge operation. Accordingly, it is possible to provide a power conversion device that uses bootstrap circuits capable of reducing cost and size while inhibiting control complications.

(Technique 5) The power conversion device according to any one of Techniques 1 to 4, wherein
the positive coupling coefficient is greater than 0.5−Vₜₕ/2Vᵢₙ, where Vᵢₙ denotes a voltage of the first input/output terminal and Vₜₕ denotes the voltage of the second node with which the charging of the bootstrap capacitor is started.

By designing a power conversion device to increase a coupling coefficient to be greater than 0.5−Vₜₕ/2Vᵢₙ, the bootstrap capacitor can be charged irrespective of the switching timing of the first switch in single-phase operation.

(Technique 6) A power conversion device configured by n phases where n is an integer greater than or equal to 2, the power conversion device comprising:
a first switch provided on a first path connecting a first input/output terminal and a second input/output terminal;
a second switch provided on the first path and connected to the first switch in series;
a first inductor provided on a second path connecting a third input/output terminal and a first node between the first switch and the second switch on the first path;
a third switch provided on a third path connecting the first input/output terminal and the second input/output terminal, the third path being different from the first path;
a fourth switch provided on the third path and connected to the third switch in series;
a second inductor provided on a fourth path connecting the third input/output terminal and a second node between the third switch and the fourth switch on the third path; and
a first bootstrap circuit including a bootstrap capacitor whose one end is connected to the second node and whose other end is connected to a drive circuit for driving the third switch, wherein
the first inductor and the second inductor are magnetically coupled to each other by a negative coupling coefficient,
when the third switch and the fourth switch are in an off-state and the power conversion device performs single-phase operation by turning on and off the first switch and the second switch, the bootstrap capacitor is charged by turning on the first switch from an off-state at a timing when a voltage of the second node is a third voltage or higher, and
the third voltage is determined based on the negative coupling coefficient, a voltage of the first input/output terminal, and a voltage of the third input/output terminal.

Since the second inductor is magnetically coupled to the first inductor, induced electromotive force is generated in the second inductor due to a voltage applied to the first inductor when the power conversion device performs single-phase operation. This induced electromotive force is the voltage of the second node and resonates in the single-phase operation. Since the voltage of the second node when the first inductor and the second inductor are magnetically coupled to each other by a negative coupling coefficient decreases when the first switch is turned on, and decreases greatly when the first switch is turned on particularly at the timing when the voltage of the second node is high, the voltage of the second node can be reduced greatly by adjusting the timing of turning on the first switch. Specifically, the voltage of the second node can be reduced greatly by turning on the first switch at the timing when the voltage of the second node is a third voltage or higher. The third voltage is determined based on the negative coupling coefficient, the voltage of the first input/output terminal, and the voltage of the third input/output terminal. Since the voltage of the second node is the voltage at one end of the bootstrap capacitor, the potential difference between the ends of the bootstrap capacitor increases owing to a great fall in the voltage of the second node and the bootstrap capacitor can be charged. This enables the second-phase circuit (specifically, the third switch) to operate normally when single-phase operation is switched to multiple-phase operation.

Thus, by magnetically coupling the first inductor and the second inductor to each other by a negative coupling coefficient and adjusting the timing of turning on the first switch based on the voltage of the second node in single-phase operation, the bootstrap capacitor can be charged without using, for instance, an isolated power supply or performing precharge operation. Accordingly, it is possible to provide a power conversion device that uses bootstrap circuits capable of reducing cost and size while inhibiting control complications.

(Technique 7) The power conversion device according to Technique 6, wherein
the third voltage is in a proportional relationship with the negative coupling coefficient, the voltage of the first input/output terminal, and the voltage of the third input/output terminal.

Thus, the bootstrap capacitor can be charged by turning on the first switch at the timing when the voltage of the second node is a third voltage or higher in single-phase operation. The third voltage is in a proportional relationship with the negative coupling coefficient, the voltage of the first input/output terminal, and the voltage of the third input/output terminal.

(Technique 8) The power conversion device according to Technique 7, wherein
the third voltage is 2×{Vₒᵤₜ−|k|×(Vᵢₙ−Vₒᵤₜ)}−Vₜₕ, where k denotes the negative coupling coefficient, Vᵢₙ denotes the voltage of the first input/output terminal, Vₒᵤₜ denotes the voltage of the third input/output terminal, and Vₜₕ denotes the voltage of the second node with which the charging of the bootstrap capacitor is started.

Thus, the bootstrap capacitor can be charged by turning on the first switch at the timing when the voltage of the second node is 2×{Vₒᵤₜ−|k|×(Vᵢₙ−Vₒᵤₜ)}−Vₜₕ or higher.

(Technique 9) A power conversion device configured by n phases where n is an integer greater than or equal to 2, the power conversion device comprising:
a first switch provided on a first path connecting a first input/output terminal and a second input/output terminal;
a second switch provided on the first path and connected to the first switch in series;
a first inductor provided on a second path connecting a third input/output terminal and a first node between the first switch and the second switch on the first path;
a third switch provided on a third path connecting the first input/output terminal and the second input/output terminal, the third path being different from the first path;
a fourth switch provided on the third path and connected to the third switch in series;
a second inductor provided on a fourth path connecting the third input/output terminal and a second node between the third switch and the fourth switch on the third path; and
a first bootstrap circuit including a bootstrap capacitor whose one end is connected to the second node and whose other end is connected to a drive circuit for driving the third switch, wherein
the first inductor and the second inductor are magnetically connected to each other by a negative coupling coefficient,
the first switch is in an on-state in a given first period in a switching cycle, and is in an off-state in a second period that follows the given first period,
when the third switch and the fourth switch are in an off-state and the power conversion device performs single-phase operation by turning on and off the first switch and the second switch, the bootstrap capacitor is charged by turning on the first switch from the off-state in the second period at a timing when a voltage of the second node is a fourth voltage or higher, and
the fourth voltage is the voltage of the second node at a timing when the first switch is turned off from the on-state in the given first period to the off-state in the second period in a case where the voltage of the second node is a voltage with which the charging of the bootstrap capacitor is started when the first switch is in the on-state in the given first period.

Since the second inductor is magnetically coupled to the first inductor, induced electromotive force is generated in the second inductor due to a voltage applied to the first inductor when the power conversion device performs single-phase operation. This induced electromotive force is the voltage of the second node and resonates in the single-phase operation. Since the voltage of the second node when the first inductor and the second inductor are magnetically coupled to each other by a negative coupling coefficient decreases when the first switch is turned on and can be decreased greatly when the first switch is turned on particularly at the timing when the voltage of the second node is high, the voltage of the second node can be reduced greatly by adjusting the timing of turning on the first switch. Specifically, the voltage of the second node can be reduced greatly by turning on the first switch at the timing when the voltage of the second node is a fourth voltage (the voltage of the second node at the timing when the first switch is turned off after the voltage of the second node decreases to be lower than a voltage with which charging of the bootstrap capacitor is started when the first switch is in an on-state) or higher. Since the voltage of the second node is the voltage at one end of the bootstrap capacitor, the potential difference between the ends of the bootstrap capacitor increases owing to a great fall in the voltage of the second node and the bootstrap capacitor can be charged. This enables the second-phase circuit (specifically, the third switch) to operate normally when single-phase operation is switched to multiple-phase operation.

Thus, by magnetically coupling the first inductor and the second inductor to each other by a negative coupling coefficient and adjusting the timing of turning on the first switch based on the voltage of the second node in single-phase operation, the bootstrap capacitor can be charged without using, for instance, an isolated power supply or performing precharge operation. Accordingly, it is possible to provide a power conversion device that uses bootstrap circuits capable of reducing cost and size while inhibiting control complications.

(Technique 10) The power conversion device according to any one of Techniques 6 to 9, wherein
an absolute value of the negative coupling coefficient is greater than (Vₒᵤₜ−Vₜₕ)/(Vᵢₙ−Vₒᵤₜ), where Vᵢₙ denotes the voltage of the first input/output terminal, Vₒᵤₜ denotes the voltage of the third input/output terminal, and Vₜₕ denotes the voltage of the second node with which the charging of the bootstrap capacitor is started.

By designing a power conversion device to increase the absolute value of a coupling coefficient to be greater than (Vₒᵤₜ−Vₜₕ)/(Vᵢₙ−Vₒᵤₜ), the bootstrap capacitor can be charged irrespective of the switching timing of the first switch in single-phase operation.

(Technique 11) The power conversion device according to any one of Techniques 1 to 10, wherein
the charging of the bootstrap capacitor is performed at least once for each period that is a least common multiple of (i) a resonance period determined based on a parasitic capacity of the third switch and inductances of the first inductor and the second inductor, and (ii) a switching cycle period when the power conversion device performs the single-phase operation.

By performing the charging of the bootstrap capacitor at least once for each period that is the least common multiple, it is possible to inhibit the charge voltage of the bootstrap capacitor from decreasing to be lower than a voltage for operating the third switch normally.

(Technique 12) The power conversion device according to Technique 11, wherein
the charging of the bootstrap capacitor is performed for each switching cycle period.

By performing the charging of the bootstrap capacitor for each switching cycle period, it is possible to inhibit the charge voltage of the bootstrap capacitor from decreasing to be lower than a voltage for operating the third switch normally.

(Technique 13) The power conversion device according to any one of Techniques 1 to 12, wherein
when the charging of the bootstrap capacitor is not performed, an on-period and an off-period of the first switch are adjusted such that the charging of the bootstrap capacitor is performed.

By adjusting an on-period and an off-period of the first switch, the timing of switching the first switch can be adjusted and the bootstrap capacitor can be charged.

(Technique 14) The power conversion device according to any one of Techniques 1 to 13, further comprising:
one or more circuits each of which includes:
a fifth switch provided on a fifth path connecting the first input/output terminal and the second input/output terminal, the fifth path being different from the first path and the third path;
a sixth switch provided on the fifth path and connected to the fifth switch in series;
a third inductor provided on a sixth path connecting the third input/output terminal and a third node between the fifth switch and the sixth switch on the fifth path; and
a second bootstrap circuit including a bootstrap capacitor whose one end is connected to the third node and whose other end is connected to a drive circuit for driving the fifth switch, wherein
the first inductor and the third inductor are magnetically coupled to each other, and
the bootstrap capacitors in the first bootstrap circuit and the second bootstrap circuit are charged by turning off the first switch from an on-state or turning on the first switch from an off-state at a timing when a voltage of at least one of the second node or the third node is a predetermined voltage or higher in a case where the third switch, the fourth switch, the fifth switch, and the sixth switch are in an off-state, and the power conversion device performs single-phase operation by turning on and off the first switch and the second switch.

Thus, even in a power conversion device configured by three or more phases, by magnetically coupling the first inductor to the second inductor and the third inductor and adjusting the timing of turning off or turning on the first switch based on the voltage of the second node or the voltage of the third node in single-phase operation, a bootstrap capacitor in a circuit configured as a second-phase circuit or a lower-phase circuit can be charged without using, for instance, an isolated power supply or performing precharge operation.

### INDUSTRIAL APPLICABILITY

The present disclosure is applicable to, for instance, power conversion devices that use bootstrap circuits.

### REFERENCE SIGNS LIST

10, 10a power conversion device
100 control circuit
110 voltage detection circuit
BS1, BS2 BS circuit
C1, C2, C3, C4, C5, C6 capacitor
C10, C20 BS capacitor
D1, D2, D3, D4, D5, D6 drive circuit
D10, D20 diode
L1, L2, L3 inductor
N1, N2, N3 connection node
P1, P2, P3, P4, P5, P6 path
Q1, Q2, Q3, Q4, Q5, Q6 switch
R10, R20 resistance
t1, t2, t3 input/output terminal
Vdd power supply

1. A power conversion device configured by n phases where n is an integer greater than or equal to 2, the power conversion device comprising:
a first switch provided on a first path connecting a first input/output terminal and a second input/output terminal;
a second switch provided on the first path and connected to the first switch in series;
a first inductor provided on a second path connecting a third input/output terminal and a first node between the first switch and the second switch on the first path;
a third switch provided on a third path connecting the first input/output terminal and the second input/output terminal, the third path being different from the first path;
a fourth switch provided on the third path and connected to the third switch in series;
a second inductor provided on a fourth path connecting the third input/output terminal and a second node between the third switch and the fourth switch on the third path; and
a first bootstrap circuit including a bootstrap capacitor whose one end is connected to the second node and whose other end is connected to a drive circuit for driving the third switch, wherein
the first inductor and the second inductor are magnetically coupled to each other by a positive coupling coefficient,
when the third switch and the fourth switch are in an off-state and the power conversion device performs single-phase operation by turning on and off the first switch and the second switch, the bootstrap capacitor is charged by turning off the first switch from an on-state at a timing when a voltage of the second node is a first voltage or higher, and
the first voltage is determined based on the positive coupling coefficient and a voltage of the third input/output terminal.

2. The power conversion device according to claim 1, wherein
the first voltage is in a proportional relationship with the positive coupling coefficient and the voltage of the third input/output terminal.

3. The power conversion device according to claim 2, wherein
the first voltage is 2×(1−k)×Vₒᵤₜ−Vₜₕ, where k denotes the positive coupling coefficient, Vₒᵤₜ denotes the voltage of the third input/output terminal, and Vₜₕ denotes the voltage of the second node with which the charging of the bootstrap capacitor is started.

4. A power conversion device configured by n phases where n is an integer greater than or equal to 2, the power conversion device comprising:
a first switch provided on a first path connecting a first input/output terminal and a second input/output terminal;
a second switch provided on the first path and connected to the first switch in series;
a first inductor provided on a second path connecting a third input/output terminal and a first node between the first switch and the second switch on the first path;
a third switch provided on a third path connecting the first input/output terminal and the second input/output terminal, the third path being different from the first path;
a fourth switch provided on the third path and connected to the third switch in series;
a second inductor provided on a fourth path connecting the third input/output terminal and a second node between the third switch and the fourth switch on the third path; and
a first bootstrap circuit including a bootstrap capacitor whose one end is connected to the second node and whose other end is connected to a drive circuit for driving the third switch, wherein
the first inductor and the second inductor are magnetically coupled to each other by a positive coupling coefficient,
the first switch is in an off-state in a first period in a given switching cycle, and is in an on-state in a second period that follows the first period,
when the third switch and the fourth switch are in an off-state and the power conversion device performs single-phase operation by turning on and off the first switch and the second switch, the bootstrap capacitor is charged by turning off the first switch from the on-state in the second period at a timing when a voltage of the second node is a second voltage or higher, and
the second voltage is the voltage of the second node at a timing when the first switch is turned on from the off-state in the first period to the on-state in the second period in a case where the voltage of the second node is lower than a voltage with which charging of the bootstrap capacitor is started when the first switch is in the off-state in the first period.

5. The power conversion device according to claim 1, wherein
the positive coupling coefficient is greater than 0.5−Vₜₕ/2Vᵢₙ, where Vᵢₙ denotes a voltage of the first input/output terminal and Vₜₕ denotes the voltage of the second node with which the charging of the bootstrap capacitor is started.

6. A power conversion device configured by n phases where n is an integer greater than or equal to 2, the power conversion device comprising:
a first switch provided on a first path connecting a first input/output terminal and a second input/output terminal;
a second switch provided on the first path and connected to the first switch in series;
a first inductor provided on a second path connecting a third input/output terminal and a first node between the first switch and the second switch on the first path;
a third switch provided on a third path connecting the first input/output terminal and the second input/output terminal, the third path being different from the first path;
a fourth switch provided on the third path and connected to the third switch in series;
a second inductor provided on a fourth path connecting the third input/output terminal and a second node between the third switch and the fourth switch on the third path; and
a first bootstrap circuit including a bootstrap capacitor whose one end is connected to the second node and whose other end is connected to a drive circuit for driving the third switch, wherein
the first inductor and the second inductor are magnetically coupled to each other by a negative coupling coefficient,
when the third switch and the fourth switch are in an off-state and the power conversion device performs single-phase operation by turning on and off the first switch and the second switch, the bootstrap capacitor is charged by turning on the first switch from an off-state at a timing when a voltage of the second node is a third voltage or higher, and
the third voltage is determined based on the negative coupling coefficient, a voltage of the first input/output terminal, and a voltage of the third input/output terminal.

7. The power conversion device according to claim 6, wherein
the third voltage is in a proportional relationship with the negative coupling coefficient, the voltage of the first input/output terminal, and the voltage of the third input/output terminal.

8. The power conversion device according to claim 7, wherein
the third voltage is 2×{Vₒᵤₜ−|k|×(Vᵢₙ−Vₒᵤₜ)}−Vₜₕ, where k denotes the negative coupling coefficient, Vᵢₙ denotes the voltage of the first input/output terminal, Vₒᵤₜ denotes the voltage of the third input/output terminal, and Vₜₕ denotes the voltage of the second node with which the charging of the bootstrap capacitor is started.

9. A power conversion device configured by n phases where n is an integer greater than or equal to 2, the power conversion device comprising:
a first switch provided on a first path connecting a first input/output terminal and a second input/output terminal;
a second switch provided on the first path and connected to the first switch in series;
a first inductor provided on a second path connecting a third input/output terminal and a first node between the first switch and the second switch on the first path;
a third switch provided on a third path connecting the first input/output terminal and the second input/output terminal, the third path being different from the first path;
a fourth switch provided on the third path and connected to the third switch in series;
a second inductor provided on a fourth path connecting the third input/output terminal and a second node between the third switch and the fourth switch on the third path; and
a first bootstrap circuit including a bootstrap capacitor whose one end is connected to the second node and whose other end is connected to a drive circuit for driving the third switch, wherein
the first inductor and the second inductor are magnetically connected to each other by a negative coupling coefficient,
the first switch is in an on-state in a given first period in a switching cycle, and is in an off-state in a second period that follows the given first period,
when the third switch and the fourth switch are in an off-state and the power conversion device performs single-phase operation by turning on and off the first switch and the second switch, the bootstrap capacitor is charged by turning on the first switch from the off-state in the second period at a timing when a voltage of the second node is a fourth voltage or higher, and
the fourth voltage is the voltage of the second node at a timing when the first switch is turned off from the on-state in the given first period to the off-state in the second period in a case where the voltage of the second node is a voltage with which the charging of the bootstrap capacitor is started when the first switch is in the on-state in the given first period.

10. The power conversion device according to claim 6, wherein
an absolute value of the negative coupling coefficient is greater than (Vₒᵤₜ−Vₜₕ)/(Vᵢₙ−Vₒᵤₜ), where Vᵢₙ denotes the voltage of the first input/output terminal, Vₒᵤₜ denotes the voltage of the third input/output terminal, and Vₜₕ denotes the voltage of the second node with which the charging of the bootstrap capacitor is started.

11. The power conversion device according to claim 1, wherein
the charging of the bootstrap capacitor is performed at least once for each period that is a least common multiple of (i) a resonance period determined based on a parasitic capacity of the third switch and inductances of the first inductor and the second inductor, and (ii) a switching cycle period when the power conversion device performs the single-phase operation.

12. The power conversion device according to claim 11, wherein
the charging of the bootstrap capacitor is performed for each switching cycle period.

13. The power conversion device according to claim 1, wherein
when the charging of the bootstrap capacitor is not performed, an on-period and an off-period of the first switch are adjusted such that the charging of the bootstrap capacitor is performed.

14. The power conversion device according to claim 1, further comprising:
one or more circuits each of which includes:
a fifth switch provided on a fifth path connecting the first input/output terminal and the second input/output terminal, the fifth path being different from the first path and the third path;
a sixth switch provided on the fifth path and connected to the fifth switch in series;
a third inductor provided on a sixth path connecting the third input/output terminal and a third node between the fifth switch and the sixth switch on the fifth path; and
a second bootstrap circuit including a bootstrap capacitor whose one end is connected to the third node and whose other end is connected to a drive circuit for driving the fifth switch, wherein
the first inductor and the third inductor are magnetically coupled to each other, and
the bootstrap capacitors in the first bootstrap circuit and the second bootstrap circuit are charged by turning off the first switch from an on-state or turning on the first switch from an off-state at a timing when a voltage of at least one of the second node or the third node is a predetermined voltage or higher in a case where the third switch, the fourth switch, the fifth switch, and the sixth switch are in an off-state, and the power conversion device performs single-phase operation by turning on and off the first switch and the second switch.
